(19) United States
(12) Patent Application Publication
(10) Pub. No.: US 2003/0154408 A1
(43) Pub. Date: Aug. 14, 2003

(54) Method and apparatus for secured unified public communication network based on IP and common channel signaling

(76) Inventors: Yanong Zhu, Scotts Valley, CA (US); Xuefei Han, Shanghai (CN)

Correspondence Address: Yanong Zhu, 5619 Scotts Valley Dr. #210, Scotts Valley, CA, 95066, US

(21) Appl. No.: 10/310,006

(22) Filed: Dec. 3, 2002

Related U.S. Application Data
(60) Provisional application No. 60/356,438, filed on Feb. 13, 2002.

(51) Int. Cl. H04L 9/00

(52) U.S. Cl. 713/201

(57) ABSTRACT

A method of building a secured unified public network for providing voice, video and data based on Internet Protocol (IP) and secured common channel signaling is disclosed. The network comprises a signaling network for common channel signaling; a data network for video, voice and data; a database for storing and processing digital keys and digital signatures; and the subscriber terminal devices connected to both the signaling network and the data network; The signaling network and database provide sign-on services, key exchange services, digital signature services and call processing services. The encrypted data are transmitted through the data network with shared keys of the caller and called parties.

### BACKGROUND OF THE INVENTION

1. Field of the Invention

This invention generally relates to digital broadband unified secured telecommunication network based on Internet Protocol (IP) for voice, video and data, and particularly to common channel signaling based on real physical or virtual private network.

2. Description of Prior Art

Though Internet can make full use of resource; the principle of “best effort” method, the lack of reliable subscriber's identification method and the lack of reliable control over network resource are limiting the ability of the current Internet to be a reliable and secure communication tool. For example, the path or trace of each packet of the voice, video and data traffic is based on “best effort” method and is controlled by Internet Protocols (IP), resulting both security and reliability concerns. An IP address can not be used as a trustable identification since it can be set by the subscriber themselves. In contrast, a subscriber in traditional Public Switched Telephone Network (PSTN) is identified through a physical address of the port on the line card that a telephone number is issued to, and the trace of the data traffic is managed by SS7 signaling network, or each subscriber in PSTN is well identified through their Physical location, and their data transmission trace is well controlled, except the limitation that the broadband data in PSTN network is expensive and difficulty to work with. The lack of the security and reliability of the Internet architecture limit the Internet to be a good solution to meet the demands of in today's fast paced world of e-Commerce, while PSTN technology just can't meet the demands for more economical broadband and easy interconnectivities.

The security of the Internet has been a long concern to many subscribers, and has caused multiple billion dollars' loss since Internet's starting to play a key role in people's daily life. For example, some of the security problems are: fake identities to access un-authorized hosts, interception of passwords and information, denial of services attack (DOS), spread of computer virus and worms, un-authorized monitoring subscribers' activities, such as changing the Web contents, unable to trace the attacking sources, and etc. All these security problems are very hard to overcome and very expensive to fix with current Internet without major enhancement of the network infrastructure functionalities.

Many methods are available today, such as Certificate Authentications with SSL, VPN, and SSH. They are very effective on preventing several types of attacks and protecting the information and network, but are difficult to setup, and are not designed for general public communication network. The DOS or flooding attack is a fundamental weakness of Internet; no technology can effectively stop it yet.

Some of the great success of PSTN services including 1-800 called party paying and 1-900 services cannot be implemented in today's Internet because lack of metered service on demand architecture.

Hence, a method of building a secured unified public network is required to overcome the disadvantages of the prior art.

### BRIEF SUMMARY OF THE INVENTION

An object of the present invention is to enhance the functionalities of the Internet, further it will enable Internet to be used as a secured public telecommunication network.

Another object of the present invention is to set up a foundation for toll services including 1-800 and 1-900 number services based on Internet Protocol (IP).

To fulfill the above mentioned objects, a secured unified network in accordance with the present invention comprises a signaling network based on secured private network for common channel signaling, a data network for voice, video and data traffic, at least two terminal devices are connected to both the signaling network and data network, and a database associated with the signaling network. The signaling network is based on a stand alone independent physical network, or a virtual private network that shares the same physical media with the data network, or a combination of a stand alone physical network and a virtual private network. The database contains pre-stored information for each subscriber and also is used to provide digital signature services. When a subscriber connects his/her terminal to the signaling network, the signal module of the terminal device will perform a sign-on process with the signaling network. The sign-on process will establish an identity of the subscriber, service privileges, security status, and other status required for services. When the caller party originate a call, his/her identity and his/her public key will be signed by the database in the signaling network and passed to a called party, and the called party will also return his/her public key via the signaling network and be signed by the signaling network to the caller party. The public keys which exchange between the caller and called party can be either fixed public keys or generated based on session-by-session to achieve maximum security. After both the caller and called party agree on each other's identity, voice, video and data will be encrypted by a shared key which is generated by negotiation of the two parties and sent between the two parties by the data network. At the same time, the signaling network saves and processes the detail billing information in the database and prepares for billing.

Other objects, advantages and novel features of the invention will become more apparent from the following detailed description of the present embodiment when taken in conjunction with the accompanying drawings.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, in which:

FIG. 1 illustrates a secured unified network for voice, video, and data;

FIG. 2 illustrates a sign-on signaling process;

FIG. 3 illustrates a calling process, public keys exchanging process and a shared key generating process.

### DETAILED DESCRIPTION OF THE INVENTION

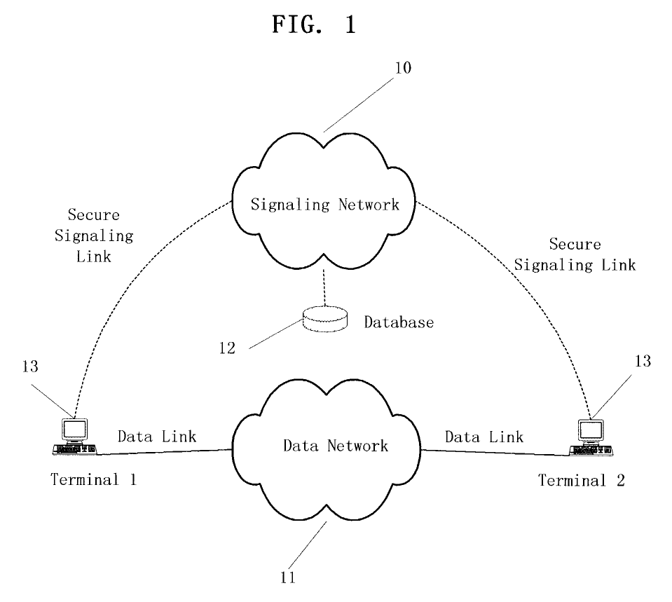

FIG. 1 illustrates a secured unified network for transmitting voice, video, and data. The network comprises the following parts: a signaling network 10 based on a secured private network for common channel signaling; a data network 11 for sending encrypted voice, video and data; a database 12 for storing and processing pre-stored information for each subscriber, as well as signing public keys and communication parameters for each subscriber; and terminal devices 13 that run the signaling software and encryption software.

The signaling network 10 is designed as a common channel signaling network. Each link between the signaling network 10 and the terminal device 13 is unique in the sense of security and is based on shared keys.

The signaling network 10 is an independent network or a virtual private network which shares the same physical media with the data network 11, or a combination of a stand alone physical network and a virtual private network.

The database 12 is connected to the signaling network 10. The database 12 stores a key for each subscriber. Different subscribers will have different keys. The keys are used to establish the identity as well to establish the privileges and service rights of each subscriber.

The database 12 also provides digital signature services for each calling process for both the caller and called parties. This is one of the additional security measures which ensure the correct public keys being used in the encryption processes. It is also used for establishing the service privileges.

A subscriber terminal device 13 is physically connected to the signaling network 10 through a wired cable, or a wireless channel, or other networks shared by more than one subscriber. The physical link between the subscribers and the signaling network 10 can be shared with the data network 11 and other subscribers or other shared physical media.

A subscriber terminal device 13 is linked to the signaling network 10 via either an independent physical media or a virtual private link that shares the physical link or network with data link and other subscribers.

Each terminal device 13 has two connections, one is to the signaling network 10 and the other is to the data network 11, and the two connections can be physically separated or share the same physical media or network.

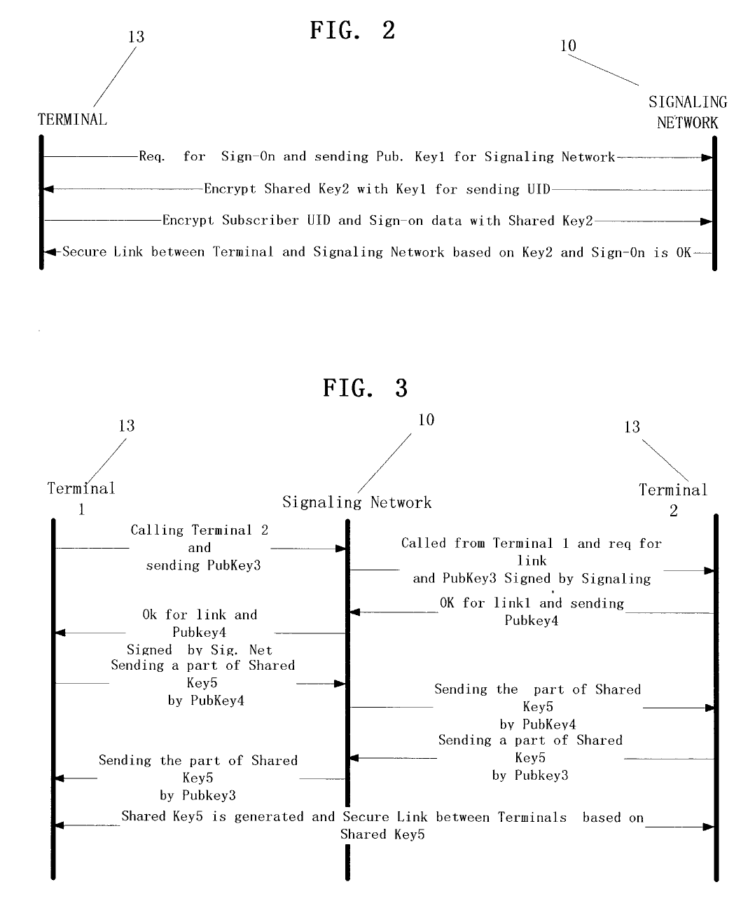

FIG. 2 illustrates a sign-on signaling process. After the subscriber terminal device 13 is linked to the signaling network 10, the subscriber terminal device 13 will send a request for sign-on with the subscriber's public key KEY1. After the signaling network 10 receives the sign-on request, it will return a shared key KEY2 encrypted with KEY1 to the subscriber. The subscriber terminal device 13 will use KEY2 to encrypt the subscriber's sign-on Universal ID (UID) which is a unique number with 16 digits used to identify each subscriber in a worldwide area. The subscriber will also use KEY2 to encrypt the sign-on subscriber's information. Both encrypted UID and sign-on subscriber's information with KEY2 will be sent to the signaling network 10 in format of IP packets for sign-on processing. Then the signaling network processes the sign-on information in comparison with information pre-stored in the signaling network database.

The signaling network database 12 contains the shared key KEY2 and the sign-on data. After the sign-on information is received from the subscriber, KEY2 will be used to de-encrypt the sign-on data and the signaling network checks the sign-on data and establishes the identities, privileges, service type, communication parameters and service rights of the subscriber. Then the signaling network 10 will send an acknowledgement back to the terminal device 13 on the success of the sign-on.

The said shared key KEY2 is generated by negotiation between the subscriber terminal devices 13 and the signaling network 10 or is only generated by the signaling network. And for each sign-on process, the shared key KEY2 will be different.

After sign-on process, the subscriber's status in the database 12 will be marked as “On Line Ready”, and the subscriber is ready now, he/she can call others or be called by others.

After sign-on, the link between the subscriber's terminal device 13 and the signaling network 10 will be based on the secure link with KEY2. From now and on, all signaling will be encrypted by KEY2.

FIG. 3 illustrates the calling process and public key exchanging process and a shared key generating process. When a subscriber terminal device 13 (here referred to as terminal 1) initials a call to another subscriber terminal 13 (here referred to as terminal 2), he/she will first create a public key KEY3. He/She will send a calling request for link along with a set of options of communication parameters and KEY3 to the signaling network 10. The signaling network 10 will digitally sign the KEY3 and forward the request to terminal 2 13. Here, terminal 1 13 and terminal 2 13 must have already signed on the signaling network 10.

After terminal 2 13 receives the request for link from terminal 1 13, he/she can decide whether to answer the call from terminal 1 13 or not. In the case that terminal 2 13 wants to answer the call from terminal 1 13, he/she will create a public key KEY4 and send it along with other communication parameters to the signaling network 10. The signaling network 10 will digitally sign KEY4 and the communication parameters and forward them to terminal 1 13 and acknowledge that the call is answered.

KEY3 and KEY4 are generated for this call only for maximum-security reasons. They can also be generated once only and for all calls.

After changing the public keys, each party generates a part of a shared key KEY5. Then each party encrypts his/her part of KEY5 by using the public key of the other party and transmits it to the other party via the signaling network 10, whereby a shared key KEY5 is generated.

After both parties get KEY5, the secure link between them is established. Each party encrypts voice, video and data by using KEY5 and transmits them to the other party via the data network 11. Then the other party uses KEY5 to de-encrypt voice, video and data after receiving them.

The shared key KEY5 is generated only for one communication session, and a new shared key is generated for a new communication session each time.

Further, A more sophisticate calling process may involve the communication parameter exchanges among the caller party, the signaling network 10 and the called party.

The caller and called party should establish their identities via the secured private common channel signaling network based on information pre-stored in the signaling network database 12. When the caller party initials a call that involves communication parameters, he/she must be sure that these parameters are acceptable by both the signaling network 10 and the called party. The caller party will send a list of options, in which are service type, bandwidth and priority, etc, to the signaling network 10. The signaling network 10 will check the called party's registered parameters and availability of the services from network and then forward a new set of parameters that the network can serve to the called party, and the called party will make a final choice on the parameters and return a decision to the signaling network 10 and finally the decision is forwarded to the caller party. If the caller party accepts the decision, the communication parameters are set.

When the caller party sends out an optional list of the parameters, he/she will also mark the priority of each option so that both the signaling network 10 and the called party can have a better understanding of the caller party's request. The highest priority option can be served first.

Either the caller party or the called party can exit the communication. If he/she wants to do so, the signaling network 10 will inform the other party and release corresponding resource.

In additional, referring to FIGS. 1, 2 and 3, toll services including 1-800 and 1-900 number services can also be provided based on the signaling network 10 and security architecture. After establishing the caller and called parties' identities by the shared keys between subscribers and the signaling network 10, the signaling system serves the request of the calling and called subscribers, then saves detailed billing information in the database 12 and processes the billing information. For example, If 800 number service is selected, the signaling system will prepare the information for billing of the called party. If 900 number service is selected, the signaling system will prepare the information for billing of the caller party.

Billing information contains the caller and called parties' identities, physical locations of the caller and called party, resource provided by the data network to meet the demands of the two parties, duration of the calling and status changes during the calling.

In the foregoing specification, the invention has been described with reference to specific embodiments thereof It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for setting up a secure channel between at least one subscriber terminal device and a secured private common channel signaling network based on Internet Protocol (IP), comprising the steps of:
(a) the subscriber terminal devices transmitting encrypted sign-on information in format of IP packets to the signaling network;
(b) the signaling network processing the sign-on information in comparison with information pre-stored in the signaling network database;
(c) the signaling network establishing the identity, privileges, service type, communication parameters, and service right of the subscriber by comparing digital signature of the sign-on information with the information pre-stored in the signaling network database; and
(d) the signaling network establishing a secured link with the subscriber terminal devices.

2. The method according to claim 1, wherein said transmitting transmits information between the subscribers and the signaling network with encryption based on public keys provided by the signaling network and shared keys.

3. The method according to claim 2, wherein said shared keys are generated by negotiation between the subscriber terminal devices and the signaling network.

4. The method according to claim 2, wherein said shared keys are generated by the signaling network.

5. The method according to claim 1, wherein said transmitting transmits the information between each subscriber and the signaling network with a unique security key.

6. The method according to claim 1, wherein said secured private common channel signaling network is a virtual private network.

7. The method according to claim 1, wherein said secured private common channel signaling network is a physically separate network from the data network for voice, video, and data.

8. The method according to claim 1, wherein said secured private common channel signaling network comprises at least one computer database server thereof.

9. The method of setting a secure communication between a caller party and a called party by using public keys, comprising the steps of:
(a) the caller and called party establishing their identities via the secured private common channel signaling network based on information pre-stored in the signaling network database;
(b) the caller and called party exchanging the public keys with digital signature of the secure common channel signaling network;
(c) each party generating a part of a shared key;
(d) each party encrypting his/her part of the shared key by using the public key of the other party and transmitting it to the other party via the signaling network, whereby the shared key is generated;
(e) each party encrypting voice, video and data by using the shared key and transmitting them to the other party via the data network; and
(f) each party de-encrypting voice, video and data from the other party by using the shared key.

10. The method according to claim 9, wherein the shared key is generated only for one communication session, and a new shared key is generated for a new communication session each time.

11. The method according to claim 9, wherein the method further provides toll services by carrying out the steps of:
(a) the signaling network establishing the caller and called party identities by information pre-stored in the signaling network database;
(b) the signaling network saving detail billing information in the database; and
(c) the signaling network processing the billing information, preparing for the billing information.

12. The method according to claim 11, wherein the toll services include 1-800 and 1-900 number services, the signaling network prepares the billing information for the called party if the 1-800 calls is selected and prepares the billing information for the caller party if the 1-900 calls is selected.

13. The method according to claim 11, wherein said billing information contains the caller and called party identities, physical locations of the caller and called party, resource provided by the data network to meet the demands of the caller and called party, duration of the calling, and status changes during the calling.

14. The method of setting communication parameters among three parties: a caller party, a called party and a secured private common channel signaling network through a communication parameter option list with priority settings, comprising the steps of:
(a) the caller and called party establishing their identities via the secured private common channel signaling network based on information pre-stored in the signaling network database;
(b) the caller party sending a list of options to the signaling network;
(c) the signaling network checking registered parameters and availability of services of the called party, forwarding a new set of parameters that the network can serve to the called party;
(d) the called party making a final choice on the parameters and returning decision to the caller party via the signaling network; and
(e) the signaling network allocating the corresponding resource if the caller party agree with the decision.

15. The method according to claim 14, wherein in the step (b), the list of options includes the service type, bandwidth and priority, etc.

16. The method according to claim 14, wherein the method, if one party wants to exit communication, the signaling system will inform the other party and release corresponding resource.
